(19) United States
(12) Patent Application Publication
(10) Pub. No.: US 2014/0254200 A1
(43) Pub. Date: Sep. 11, 2014

(54) HIGH RESOLUTION RECTIFIER SUITABLE FOR LOW VOLTAGE SIGNALS

(71) Applicant: Kuei-Wei Kuo, Hsinchu County (TW)

(72) Inventor: Kuei-Wei Kuo, Hsinchu County (TW)

(21) Appl. No.: 13/784,843

(22) Filed: Mar. 5, 2013

(51) Int. Cl. H02M 7/12

(52) U.S. Cl. CPC H02M 7/12
USPC 363/13

(57) ABSTRACT

A high resolution rectifier suitable for low voltage signals includes a signal input end connected to a signal source for inputting an original AC current; two amplifiers; one receiving the original AC current from a positive end; and the other receiving the AC current from a negative end; amplification factors of the two amplifiers being reversed to each other; two half wave rectifiers each connected to a respective amplifier selected from the two amplifiers; each half wave rectifier receiving an output from the respective amplifier and removing negative half parts of the input current; and an adder connected to the two half wave rectifiers for adding outputs from the two half wave rectifiers so as to full-wave rectifying of the original AC current.

### FIELD OF THE INVENTION

The present invention relates to a rectifier suitable for low voltage circuits, and in particular to a high resolution rectifier suitable for low voltage signals.

### BACKGROUND OF THE INVENTION

With reference to FIG. 2, conventionally, the rectifications of AC (alternative current) currents are performed by bridge rectifier circuits. However, in bridge rectifiers, all the positive and negative currents must flow through two diodes, while each diode has a specific voltage reduction. In current manufacture technology, each diode has a 0.2 to 0.4 volts of voltage reduction. If the voltage of the signal is small, this voltage reduction cannot be identified. Especially, when the noise level is high, it will induce the distortion of the output signals.

Currently, currents used in electronic systems are smaller and smaller, for example, conventional tungsten bulbs have voltage levels which are several times of the current levels used in current used LEDs. As a result, the conventional used bridge rectifier can be effectively identified the currents used in LEDs, and furthermore, the succeeding control system connected to the LEDs cannot effectively operate.

Conventionally, the input voltage can be amplified and then inputted to a bridge rectifier, but this way needs high costs.

Therefore, the object of the present invention is to provide a novel way which can improve the above mentioned defect in prior arts.

### SUMMARY OF THE INVENTION

Therefore, to resolve the above mentioned prior art defects, the present invention provides a high resolution rectifier suitable for low voltage signals. By the present invention, when the input AC voltage is very small, since the voltage reduction is low in the circuit of the present invention, the overall output voltage is still identified. Therefore, when the voltage level in a circuit is very small, the structure of the present invention is still usable. Moreover, all elements used in the system of the present invention are cheap so that the whole manufacture cost is low. In practice, the whole voltage reduction of the present invention is not greater than 0.2 volts. The signal resolution is much higher than the prior art rectifier using bridge circuits.

To achieve above object, the present invention provides a high resolution rectifier suitable for low voltage signals including a signal input end connected to a signal source for inputting an original AC current; two amplifiers; one receiving the original AC current from a positive end; and the other receiving the AC current from a negative end; amplification factors of the two amplifiers being reversed to each other; two half wave rectifiers each connected to a respective amplifier selected from the two amplifiers; each half wave rectifier receiving an output from the respective amplifier and removing negative half parts of the input current; and an adder connected to the two half wave rectifiers for adding outputs from the two half wave rectifiers so as to full-wave rectifying of the original AC current.

### BRIEF DESCRIPTION OF THE DRAWINGS

FIG. 1 is a circuit diagram of the present invention.

FIG. 2 is a circuit diagram showing the prior art diode bridge rectifier.

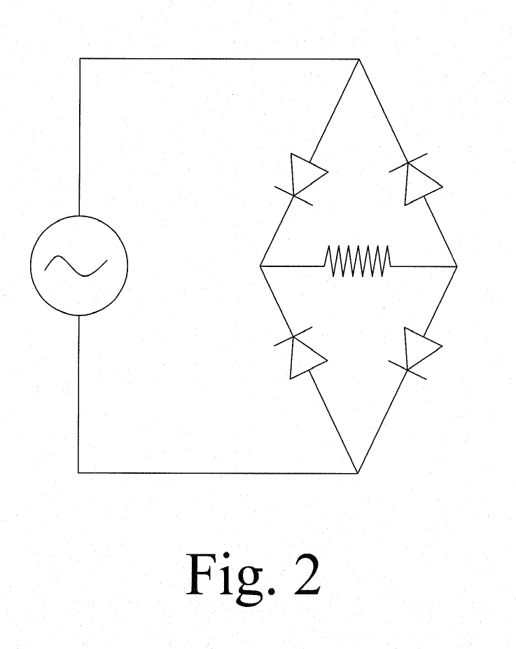

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

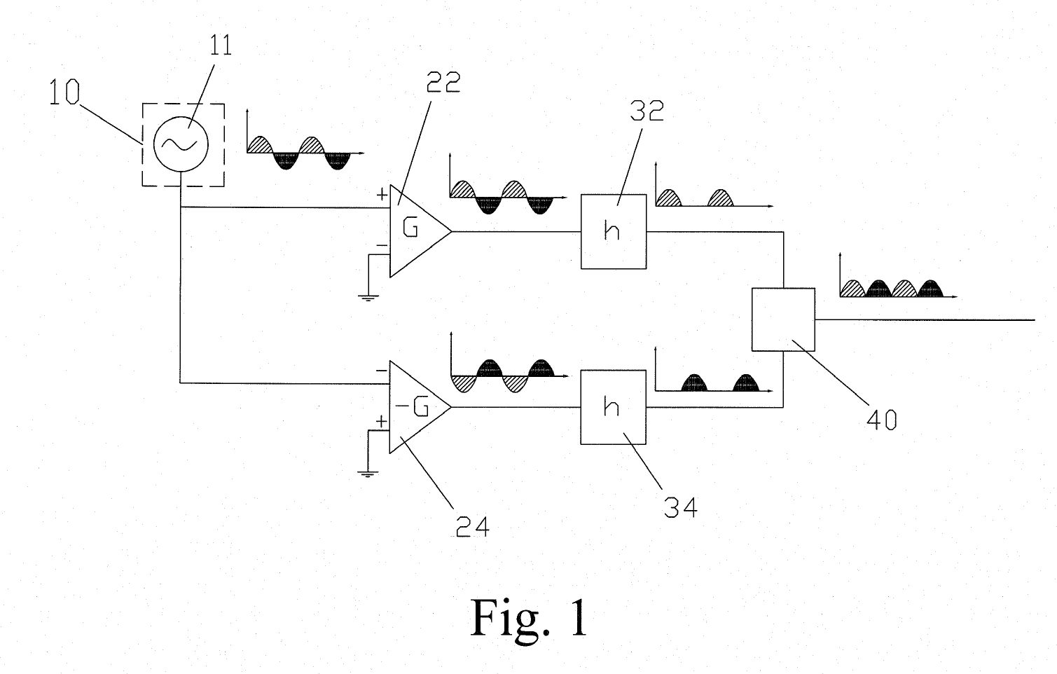

With reference to FIG. 1, the structure of the present invention is illustrated. The present invention includes the following elements.

A signal input end 10 is connected to a signal source 11 for receiving an AC current from the signal source 11. The signal source 11 outputs an AC current, in the following, it is also called as an original AC current so as to be identified from other currents outputted from other elements.

A first amplifier 22 has a positive end and a negative end. The positive end is connected to the signal input end 10 for receiving the input AC current from the signal input end 10 and the negative end is grounded. The first amplifier 22 has an amplification factor of G. Therefore, the AC current at the output end of the first amplifier 22 is G times of the original AC current inputted to the first amplifier 22.

A second amplifier 24 has a positive end and a negative end. The second amplifier 24 is synchronous with the first amplifier 22. The negative end is connected to the signal input end 10 for receiving the input AC current from the signal input end 10. The positive end of the second amplifier 24 is grounded. The second amplifier 24 has an amplification factor of −G. Therefore, the current at the output end of the second amplifier 24 is −G times of the original AC current inputted to the second amplifier 24. Namely, the second amplifier 24 amplifies the original AC current G times and also reverses the amplified AC current. Therefore, the output AC current of the second amplifier 24 is synchronous and reversed to the output AC current of the first amplifier 22.

A first half wave rectifier 32 is connected to the output end of the first amplifier 22 for receiving the output AC current from the first amplifier 22 and half-wave rectifying input current so as to remove negative parts of the AC current outputted from the first amplifier 22. Only the positive parts of the AC current outputted from the first amplifier 24 is remained. However, this positive parts at the output end of the first half wave rectifier 32 are the positive parts of the current outputted from the signal source 11, but is amplified with a factor of G.

A second half wave rectifier 34 is connected to the output end of the second amplifier 24 for receiving the AC current outputted from the second amplifier 24 and half-wave rectifying the current so as to remove the negative parts of the AC current outputted from the second amplifier 24. Only the positive parts of the AC current outputted from the second amplifier 24 is remained, however, this positive parts at the output end of the second half wave rectifier 34 is the negative parts of the current outputted from the signal source 11, but is reversed and amplified with a factor of G.

An adder 40 is connected to the output end of the first half wave rectifier 32 and the second half wave rectifier 34 for synchronously adding the outputs from the first half wave rectifier 32 and the second half wave rectifier 34. The adder 40 has a first end receiving the outputted signals from the first half wave rectifier 32 (which is the amplified positive parts of the current from the source 11 with an amplification factor of G) and a second end receiving the outputted current from the second half wave rectifier 34 (which is the amplified negative parts of the current from the source 11 with an amplification factor of −G) and adds the two currents along time axis. With reference to FIG. 1, since the outputted current from the first half wave rectifier 32 is the upper half of the original AC current from the signal source 11 with an amplification of G and the outputted current from the second half wave rectifier 34 is a lower half of the original current from the signal source 11 with an amplification of −G. Therefore, the output of the output end of the adder 40 is full wave rectification of the original AC current from the signal source 11 with an amplification of G.

The signal distributions before and after each element above mentioned are shown in FIG. 1 and attached to the related elements.

Therefore, the signals after adder 40 can be provided to the proceeding elements for further usage.

The object of the present invention is to improve the defects in the prior art and the number of diodes in rectifiers is reduced so that the whole voltage reduction in rectification is reduced. As a result, when the input AC voltage is very small, since the voltage reduction is low, the overall output voltage is still identified. Therefore, when the voltage level in a circuit is very small, the structure of the present invention is still usable. Moreover, all elements used in the system of the present invention are cheap so that the whole manufacture cost is low. In practice, the whole voltage reduction of the present invention is not greater than 0.2 volts. Therefore, the signal resolution is very higher than the prior art rectifier using bridge circuits.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A high resolution rectifier suitable for low voltage signals, comprising:
a signal input end connected to a signal source for inputting an original AC current;
two amplifiers; one receiving the original AC current from a positive end; and the other receiving the AC current from a negative end; amplification factors of the two amplifiers being reversed to each other;
two half wave rectifiers each connected to a respective amplifier selected from the two amplifiers; each half wave rectifier receiving an output from the respective amplifier and removing negative half parts of the input current; and
an adder connected to the two half wave rectifiers for adding outputs from the two half wave rectifiers so as to full-wave rectifying of the original AC current.

2. A high resolution rectifier suitable for low voltage signals, comprising:
a signal input end connected to a signal source for receiving an AC current from the signal source;
a first amplifier having a positive end and a negative end; the positive end being connected to the signal input end for receiving the AC current from the signal input end and the negative end thereof being grounded; the first amplifier having a first amplification factor; therefore, the AC current at the output end of the first amplifier being amplified with the first amplification factor;
a second amplifier having a positive end and a negative end; the negative end being connected to the signal input end for receiving the AC current from the signal input end; the positive end of the second amplifier being grounded; the second amplifier having a second amplification factor which is a negative value of the first amplification factor; therefore, a current at the output end of the second amplifier having values identical to, but negative to the output current of the first amplifier;
a first half wave rectifier connected to the output end of the first amplifier for receiving the AC current outputted from the second amplifier and half-wave rectifying the AC current to remove negative parts of the AC current outputted from the first amplifier; output current from the first half wave rectifier being the positive parts of the current outputted from the signal source, but being amplified with the first amplification factor;
a second half wave rectifier connected to the output end of the second amplifier for receiving the AC current outputted from the second amplifier and half-wave rectifying the current so as to remove the negative parts of the AC current outputted from the second amplifier so that only the positive parts of the AC current outputted from the second amplifier are remained, which is the negative parts of the current outputted from the signal source, but is reversed and amplified with a first amplification factor; and
an adder connected to the output end of the first half wave rectifier and the second half wave rectifier for synchronously adding the outputs from the first half wave rectifier and the second half wave rectifier; wherein the adder has a first end receiving the outputted signals from the first half wave rectifier (which is the positive parts of the current from the source with the first amplification factor) and a second end receiving the outputted current from the second half wave rectifier (which is the amplified negative parts of the current from the source with the first amplification factor and adds the two currents along time axis.
